(19) United States
(12) Patent Application Publication
(10) Pub. No.: US 2024/0221261 A1
(43) Pub. Date: Jul. 4, 2024

(54) DATA PROCESSING METHOD AND ELECTRONIC DEVICE

(71) Applicant: Lenovo (Beijing) Limited, Beijing (CN)

(72) Inventor: Hongwei LI, Beijing (CN)

(21) Appl. No.: 18/389,121

(22) Filed: Nov. 13, 2023

(30) Foreign Application Priority Data
Dec. 31, 2022 (CN) 202211738417.9

(51) Int. Cl. G06T 13/40; G06T 13/20; G06V 10/22; G06V 40/20

(52) U.S. Cl. CPC G06T 13/40; G06T 13/205; G06V 10/22; G06V 40/23

(57) ABSTRACT

A data processing method applied to a first device includes obtaining action data of a target user, and transmitting the action data to a second device, such that the second device outputs a virtual character corresponding to the target user at least according to the action data.

### CROSS-REFERENCE TO RELATED APPLICATION

This application claims priority to Chinese Patent Application No. 202211738417.9, filed on Dec. 31, 2022, the entire content of which is incorporated herein by reference.

### TECHNICAL FIELD

The present disclosure generally relates to the field of data processing technologies and, more particularly, to a data processing method and an electronic device.

### BACKGROUND

With the development of technology, the application of virtual characters is becoming more and more popular. However, virtual character data is transmitted between a collection device where a staff member is located and an output device where a virtual character is located, and therefore the amount of data transmission is large.

### SUMMARY

In accordance with the present disclosure, there is provided a data processing method applied to a first device including obtaining action data of a target user, and transmitting the action data to a second device, such that the second device outputs a virtual character corresponding to the target user at least according to the action data.

Also in accordance with the present disclosure, there is provided an electronic device including a processor configured to obtain action data of a target user, and a transmitter configured to transmit the action data to a second device, such that the second device outputs a virtual character corresponding to the target user at least according to the action data.

### BRIEF DESCRIPTION OF THE DRAWINGS

FIG. 1 is a flow chart of a data processing method consistent with the present disclosure.

FIG. 2 is a schematic diagram showing an application scenario of a data processing method consistent with the present disclosure.

FIG. 3 is a schematic diagram showing key points in action data consistent with the present disclosure.

FIG. 4 is a flow chart of a part of a data processing method consistent with the present disclosure.

FIG. 5 is a schematic diagram showing another application scenario of a data processing method consistent with the present disclosure

FIG. 6 is a schematic diagram showing sub-images of a target image consistent with the present disclosure.

FIG. 7 is a schematic diagram showing sub-images corresponding to different parts obtained by multiple cameras consistent with the present disclosure.

FIG. 8 is a schematic diagram showing sub-images corresponding to different parts obtained by one camera consistent with the present disclosure.

FIG. 9 is another flow chart of a part of a data processing method consistent with the present disclosure.

FIG. 10 is a schematic structural diagram showing a data processing device consistent with the present disclosure.

FIG. 11 is a schematic structural diagram showing an electronic device consistent with the present disclosure.

FIG. 12 is another schematic structural diagram showing an electronic device consistent with the present disclosure.

FIG. 13 is another schematic structural diagram showing an electronic device consistent with the present disclosure.

FIG. 14 is a flow chart of an application in a smart customer service scenario consistent with the present disclosure.

### DETAILED DESCRIPTION OF THE EMBODIMENTS

Hereinafter, embodiments and features consistent with the present disclosure will be described with reference to drawings.

Various modifications may be made to the embodiments of the present disclosure. Thus, the described embodiments should not be regarded as limiting, but are merely examples. Those skilled in the art will envision other modifications within the scope and spirit of the present disclosure.

The accompanying drawings, which are incorporated in and constitute a part of this specification, illustrate embodiments of the present disclosure and, together with the general description of the present disclosure above and the detailed description of the embodiments below, serve to explain the principle of the present disclosure.

These and other features of the present disclosure will become apparent from the following description of non-limiting embodiments with reference to the accompanying drawings.

Although the present disclosure is described with reference to some specific examples, those skilled in the art will be able to realize many other equivalents of the present disclosure.

The above and other aspects, features, and advantages of the present disclosure will become more apparent in view of the following detailed description when taken in conjunction with the accompanying drawings.

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure.

In the present disclosure, the phrases such as “in one embodiment,” “in another embodiment,” “in yet another embodiment,” or “in other embodiments,” may all refer to one or more of different embodiments in accordance with the present disclosure.

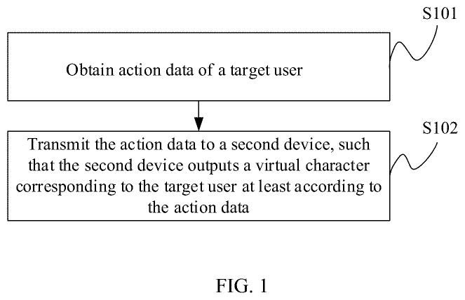

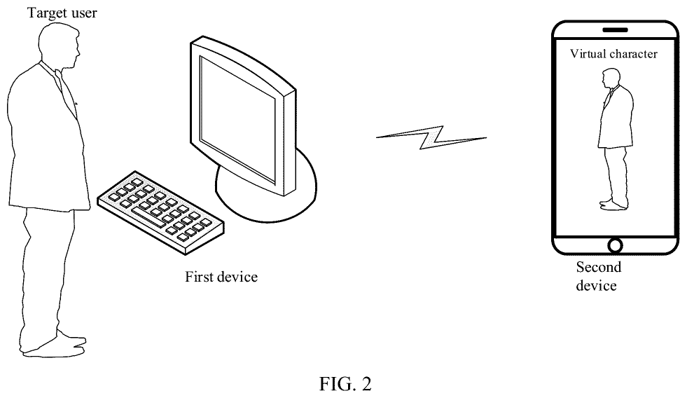

The present disclosure provides a data processing method. FIG. 1 is a flowchart of the data processing method provided by one embodiment of the present disclosure. The method may be applied to an electronic device capable of data processing and data transmission, for example, the first device shown in FIG. 2. The first device may be a computer, a server, and so on. Data connection may be established between the first device and a second device. The second device may be a device capable of outputting a virtual character, such as a computer or a server with an output device. The output device may be a device capable of outputting the virtual character, such as a display panel or a projector. In the present disclosure, the amount of data transmission between devices may be reduced when the virtual character is output on the device.

In one embodiment, the method may include S101 and S102.

In S101, action data of a target user may be obtained.

The action data of the target user may represent the action state of at least one part of the target user. Taking the arm as an example, the action data may represent the action states of the arm such as raising, lowering, or moving left or right.

The action data may include action parameters of at least one key point on a corresponding part, and the action parameters may include the offset position and/or offset direction of the key point. Based on this, for different parts, the action parameters of the key points on the part may represent the action state of the parts.

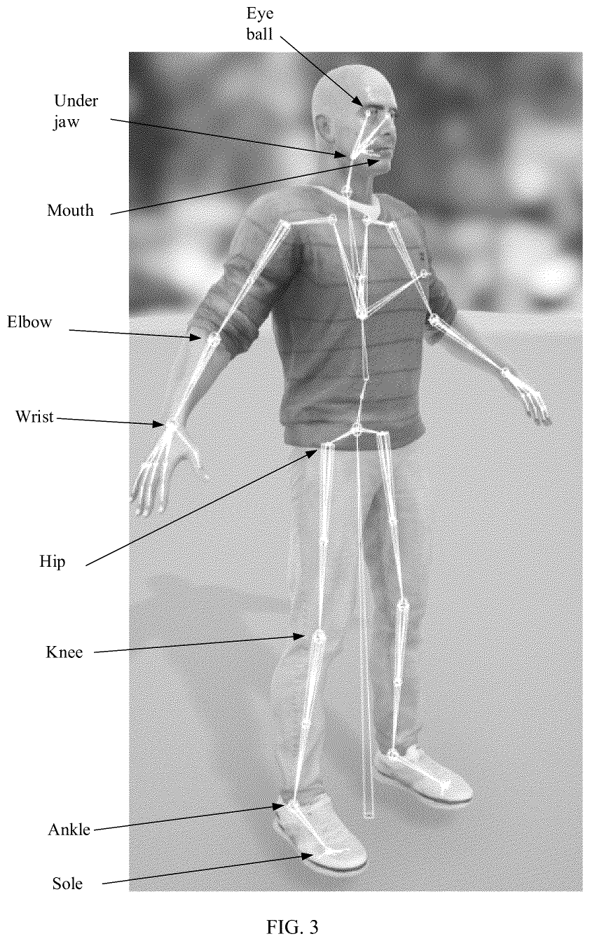

For example, in one embodiment shown in FIG. 3, the offset position and offset direction of the key points such as the elbow and wrist on the arm represent the action states of the arm such as raising, lowering, or moving left and right. In another example, the offset positions and directions of multiple key points of the eyeball, mandible, and mouth on the face represent facial expression states, such as smiling, talking, crying, etc. In another example, the offset positions and directions of key points on the legs such as hips, knees, ankles, or soles, represents the action states of the leg such as raising, lowering, or moving left and right.

In one embodiment, a data acquisition device may be pre-configured for the target user. Based on this, target data of the target user, such as images and/or sensor acquisition parameters, etc., may be obtained through the data acquisition device, and then the action data of the target user may be obtained based on these target data.

In S102, the action data may be transmitted to the second device, such that the second device outputs the virtual character corresponding to the target user at least according to the action data.

The virtual character may be understood as a virtual user corresponding to the target user, such as a three-dimensional virtual human. The virtual character may include virtual sub-objects corresponding to various parts of the target user. For example, in one embodiment as shown in FIG. 2, a three-dimensional virtual human corresponding to the target user is rendered on the second device according to the action data, such that a user of the second device is able to view the three-dimensional virtual human and the actions of the three-dimensional virtual human are consistent with the target user's actions, therefore achieving remote interaction with the target user through the three-dimensional virtual human.

In one embodiment, the virtual character may be data after pixel rendering, and may include parameter data of each pixel in the three-dimensional space, such as depth, color, brightness, etc. Compared with the action parameters of the key points of the action data, the amount of data of the virtual character may be significantly higher than the amount of data of action data.

In the data processing method provided by the present disclosure, after obtaining the action data of the target user on the first device, the action data may be transmitted to the second device and the second device may output the target virtual character corresponding to the target user according to the action data. Instead of the data of the target character, the action data for outputting the target character may be transmitted between the first device and the second device in the present disclosure, and the data amount of the action data may be significantly smaller than the data amount of the virtual character. Therefore, in the present disclosure, when the virtual character is output on the devices, the action data with the smaller data amount may be transmitted between the devices, reducing the amount of data transmission between devices.

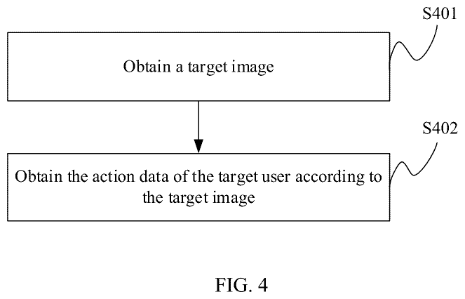

In one embodiment, as shown in FIG. 4, obtaining the action data of the target user in S101 may include S401 and S402.

In S401, target image may be obtained.

The target image may include an image region corresponding to the target user.

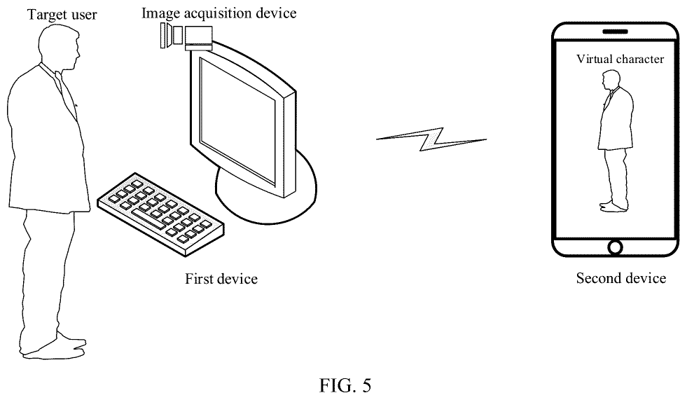

For example, as shown in FIG. 5, in one embodiment, the image acquisition device may be provided on a side of the first device, and may be used to perform image acquisition on the target user, to obtain the target image including the target region corresponding to the target user.

In S402, the action data of the target user may be obtained based on the target image.

Image processing may be performed on the target image to obtain the action data of the target user in the target image.

For example, in one embodiment, a pre-trained image recognition model may be used to perform image recognition on multiple frames of target image, such that the image recognition model outputs the action data of the target user in the target image. The image recognition model may take images including people as input samples, may use the action data of the people in the images as output samples, and may be trained multiple times.

In another embodiment, an action capture algorithm may be used to perform action capture processing on the actions of people in consecutive multiple frames of target image, to obtain the action data of the target user in the target image.

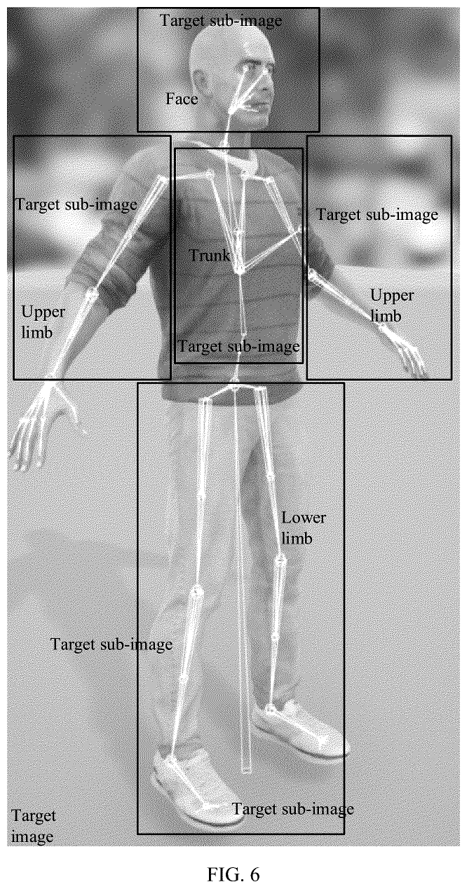

In one embodiment, one frame of target image may include multiple target sub-images, and one target sub-image may include an image area of a part of the target user. For example, as shown in FIG. 6, each frame of the target image includes target sub-images including the face, trunk, upper limbs, lower limbs, or other parts of the target user respectively.

When obtaining the action data of the target user based on the target image in S402, the action sub-data of the target user on one part corresponding to one target sub-image may be obtained based on the target sub-image. All action sub-data may constitute the action data of the target user.

That is, for each part of the target user, the action sub-data corresponding to the part may be obtained according to one target sub-image corresponding to the part, to obtain the action data of the target user including the action sub-data of all parts.

In one embodiment, one target sub-image may be obtained through one corresponding image acquisition device, and the image acquisition devices corresponding to the target sub-images of different parts may have different image acquisition parameters. The image acquisition parameters may include at least one of acquisition resolution or acquisition range.

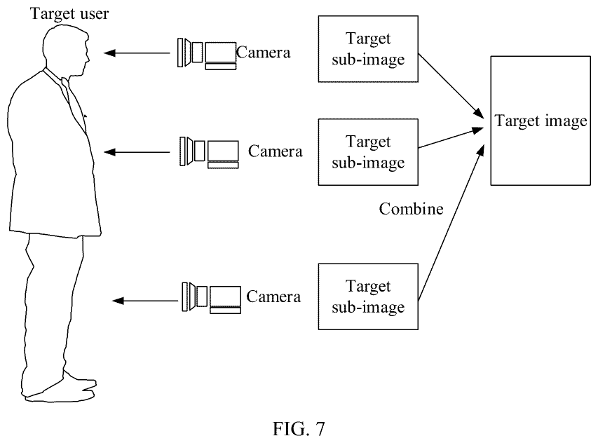

For example, as shown in FIG. 7, in one embodiment, image acquisition devices with different image acquisition parameters are configured on one side of the first device side for different parts of the target user. For example, multiple image acquisition devices with different resolutions may be configured on one side of the first device and the collection direction of each camera may point to one corresponding part such that the collection range of the camera includes the corresponding part. Therefore, in this embodiment, each image acquisition device may be used to collect images of one corresponding part of the target user, to obtain a target sub-image that respectively include image areas corresponding to the corresponding part of the target user. There may be at least two target sub-images with different image sharpness (corresponding to the resolution of the cameras). Therefore, the target image including multiple target sub-images may be obtained. The action sub-data corresponding to each part of the target user may be obtained according to the target sub-image captured by each image acquisition device, to obtain the action data of the target user

In another embodiment, all target sub-images in one frame of the target image may be obtained through one image acquisition device, and the target sub-images may be obtained by region division of the target image according to the parts of the target user.

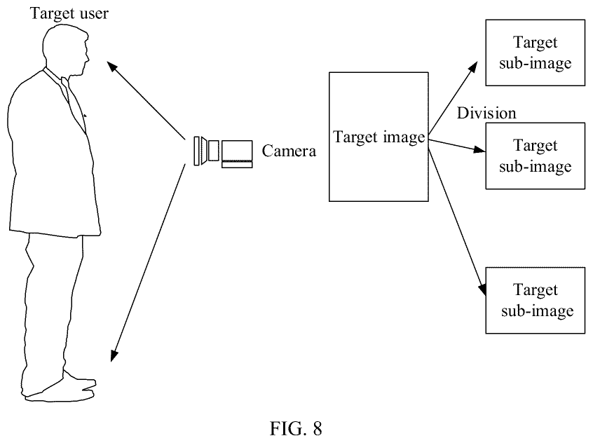

For example, as shown in FIG. 8, in one embodiment, an image collection device is configured for the target user on the side of the first device. For example, a high-definition camera is configured on one side of the first device, and the collection direction of the high-definition camera points to the target user such that the acquisition range of the high-definition camera includes the target user. Therefore, the image acquisition device may be used to collect an image of the entire region of the target user to obtain the target image that includes the entire region of the target user. Subsequently, the region division may be performed on the target image according to each part of the target user, to obtain the target sub-images corresponding to each part of the target user. Based on this, in this embodiment, the action sub-data of the target user on each part is obtained according to each target sub-image, thereby obtaining the action data of the target user. Therefore, the action sub-data corresponding to each part of the target user may be obtained according to each target sub-image, to obtain the action data of the target user.

Therefore, in S402, when the action sub-data of the target user on one part corresponding to one target sub-image may be obtained based on the target sub-image, the target sub-image may be processed separately according to a variety of processing methods to obtain the action sub-data of the target user on the part corresponding to the target sub-object. Different target sub-objects may correspond to different processing methods.

The processing methods may be methods based on processing parameters, and the processing parameters may include an image recognition model, or at least one of the processing frame rate and processing accuracy in the motion capture algorithm. Each part may correspond to one image recognition model, and the image recognition models corresponding to different parts may be different. The image recognition model corresponding to each part may be trained according to the training samples corresponding to the part. The training samples may include input samples and output samples. The input samples may include the image of the part, and the output sample may include the part action data corresponding to the image of the part. The difference between different image recognition models may include: different model types in the image recognition model, and/or different key point densities in the part action data in the output samples of the image recognition models. The different model types of the image recognition models may include that image recognition models corresponding to different parts are built based on different model algorithms.

For example, taking the face and trunk of the target user as an example, the image recognition model for the face may be built based on a machine learning algorithm with higher accuracy, and the image recognition model for the trunk may be built based on a machine learning algorithm with lower accuracy.

For another example, take the face and trunk of the target user as an example, the image recognition model of the face and the image recognition model of the trunk may be pre-trained according to the image of the face and the image of the trunk respectively. The density of the key points in the action data of the output samples of the image recognition model for the face may be higher, while the density of key points in the action data in the output sample of the image recognition model of the trunk may be lower. Based on this, different image recognition models may be used to process the target sub-images of the face and trunk respectively, to obtain the action data of the face and the action data of the trunk.

The action capture algorithm may be able to process the pixels in the image to capture the action data of specific objects in the image. The action capture algorithm may have parameters such as a processing frame rate or a processing accuracy, and different parts may have different processing frame rates and/or processing accuracy.

In one embodiment, taking the face and trunk of the target user as an example, a higher first processing frame rate and a higher first processing accuracy may be used to perform action capture on the target sub-image corresponding to the face, and then the action data of the face may be obtained. A lower second processing frame rate and a lower second processing accuracy may be used to perform action capture on the target sub-image corresponding to the trunk, and then the action data of the trunk may be obtained.

In one embodiment, a plurality of cameras with different resolutions may be disposed on one side of the first device, and the collection range of each camera may include its corresponding part. High-definition cameras of the plurality of cameras may collect the target sub-image including the face at a high collection frame rate, and the low-definition cameras of the plurality of cameras may collect the target sub-image including the trunk at a low acquisition frame rate, and so on. Subsequently, an action capture algorithm with a higher first processing frame rate and a higher first processing accuracy may be used to process the target sub-image corresponding to the face to obtain the action data on the face. An action capture algorithm with a lower second processing frame rate and a lower second processing accuracy may be used to process the target sub-image corresponding to the trunk, and the action data of the trunk may be obtained. The action capture algorithm with the same second processing frame rate and second processing precision may be used to process target sub-images corresponding to other parts are processed, to obtain the action data on these parts, and so on.

In another embodiment, an image acquisition device may be disposed on one side of the first device for the target user. For example, a high-definition camera may be disposed on one side of the first device, and the collection direction of the high-definition camera may point to the target user such that the collection range of the high-definition camera includes the target user. Therefore, the high-definition camera may collect the high-definition target image including various parts of the target user. The target image may be divided according to the various parts of the target user, and the target sub-images corresponding to various parts of the target user may be obtained, such as the target sub-image including the face and the target sub-image including the trunk, and so on. Subsequently, an action capture algorithm with a higher processing frame rate and a higher processing accuracy may be used to process the target sub-image corresponding to the face to obtain the action data on the face. An action capture algorithm with a lower processing frame rate and a lower processing accuracy may be used to process the target sub-image corresponding to the trunk, and the action data of the trunk may be obtained. Another action capture algorithm with a same processing frame rate and a same processing precision may be also used to process target sub-images corresponding to other parts are processed, to obtain the action data on these parts, and so on.

In another embodiment, an image acquisition device may be disposed on one side of the first device for the target user. For example, a high-definition camera may be disposed on one side of the first device, and the collection direction of the high-definition camera may point to the target user such that the collection range of the high-definition camera includes the target user. Therefore, the high-definition camera may collect the high-definition target image including various parts of the target user. The target image may be divided according to the various parts of the target user, and the target sub-images corresponding to various parts of the target user may be obtained, such as the target sub-image including the face and the target sub-image including the trunk, and so on. Subsequently, the corresponding target sub-image of each part may be processed separately according to the image recognition model trained for the part. For example, the target sub-image corresponding to the face may be recognized and processed with the image recognition model trained according to the facial image, to obtain the action data of the face output by the image recognition model. The image recognition model trained according to the trunk may be used to recognize and process the target sub-image corresponding to the trunk, to obtain the action data of the trunk output by the image recognition model. The corresponding image recognition models may be used to recognize and process the target sub-images corresponding to other parts, to obtain the action data of these parts, and so on.

In one embodiment, in S101, the action data of the target user may be obtained by:

according to various processing methods, obtaining multiple pieces of action sub-data of the target user respectively. One piece of action sub-data may correspond to one part of the target user, and all the pieces of action sub-data may form the action data of the target user. Different action sub-data may correspond to different processing methods.

In this embodiment, for different parts of the target user, the action sub-data corresponding to each part may be obtained according to different processing methods, thereby obtaining the action data of the target user.

In one embodiment, the action sub-data may be obtained based on target sub-data, and one piece of target sub-data may correspond to one part of the target user. In S101, the target sub-data corresponding to each part of the target user may be first obtained, and then the action sub-data corresponding to each part may be obtained according to the corresponding target sub-data.

Therefore, in one embodiment, the processing methods for obtaining the action sub-data may be based on acquisition modes of data acquisition devices. The data acquisition devices may be used to obtain target sub-data. The data acquisition devices corresponding to some different parts may have different types, or the data acquisition devices corresponding to some different parts may have a same type. The data acquisition devices corresponding to some different parts may have different device parameters, or the data acquisition devices corresponding to some different parts may have same device parameters.

The device types of the data acquisition devices may be the device types of the image acquisition devices or the device type of the wearable device. For example, the action sub-data corresponding to the face may be obtained based on the target sub-data collected by the corresponding camera, the action sub-data corresponding to the trunk may be obtained based on the target sub-data collected by the corresponding camera, and the action sub-data corresponding to the fingers may be obtained based on the target sub-data collected by the corresponding wearable device, and so on.

The device parameters of the data acquisition devices may include: image acquisition resolution of the image acquisition devices, or sensor acquisition density of the wearable devices, or image acquisition frame rate (i.e., acquisition frequency) of the image acquisition devices, etc.

For example, in one embodiment, the action sub-data corresponding to the face may be obtained based on the target sub-data collected by a camera with high resolution and high acquisition frame rate, the action sub-data corresponding to the trunk may be obtained based on the target sub-data collected by a camera with low resolution and low acquisition frame rate, the action sub-data corresponding to the fingers may be obtained based on the target sub-data collected by the wearable device with sensors of a higher density, and the action sub-data corresponding to the limbs may be obtained based on the target sub-data collected by the wearable device with sensors of a lower density, and so on.

For another example, in another embodiment, the action sub-data corresponding to the face may be obtained based on the target sub-data collected by the wearable device with sensors of a higher density, the action sub-data corresponding to the trunk may be obtained based on the target collected by the wearable device with sensors of a lower density, the action sub-data corresponding to the fingers may be obtained based on the target sub-data collected by the wearable device with sensors of a higher density, and the action sub-data corresponding to the limbs may be obtained based on the target sub-data collected by the wearable device with sensors of a lower density, and so on.

In one embodiment, the processing methods for obtaining the action sub-data may be the methods for processing target sub-data, and different parts may correspond to different processing parameters for processing target sub-data. That is, after obtaining the target sub-data corresponding to each part of the target user, the target sub-data corresponding to different parts may be processed with different processing parameters to obtain the action sub-data corresponding to each part.

The processing parameters may include at least one of: accuracy of processing the target sub-data or frame rate of processing the target sub-data.

The different accuracy of processing target sub-data may be understood as the different data processing amount in one target sub-data per unit area of each part, and the different frame rate of processing target sub-data may be understood as the number of the sub-data processed in unit time for each part.

For example, in one embodiment, the target sub-data corresponding to the face may be processed with higher processing accuracy and higher processing frame rate to obtain the action sub-data corresponding to the face, and the target sub-data corresponding to the trunk may be processed with lower processing accuracy and lower processing frame rate to obtain the action sub-data corresponding to the trunk.

For another example, in another embodiment, the target sub-image corresponding to the face may be processed at a frame rate of 60 frames/second to obtain the action sub-data corresponding to the face, and the target sub-image corresponding to the trunk may be processed at a frame rate of 30 frames/second to obtain the action sub-data corresponding to the trunk.

For another example, in another embodiment, the sensor collection parameters corresponding to the face (collected by the wearable device) may be processed with a higher frame rate and higher accuracy to obtain the action sub-data corresponding to the face; and the sensor collection parameters corresponding to the trunk may be processed at a lower frame rate and lower precision to obtain the action sub-data corresponding to the trunk.

In the present disclosure, the parts of the target user may be divided into different levels according to the degree of attention or influence. For parts with a high level of attention or a high level of influence, the corresponding action data may be obtained with a higher frame rate and higher precision. Therefore, the second device receiving the action data may be able to output the virtual character according to the more accurate action data.

For parts with a lower level of attention or a lower level of influence, the corresponding action data may be obtained by sampling at a lower frame rate and lower precision. Since the frame rate and accuracy are both lower, the amount of data processing when obtaining the action data may be low. Therefore, the amount of data processing may be reduced, reducing the amount of data transmitted to the second device.

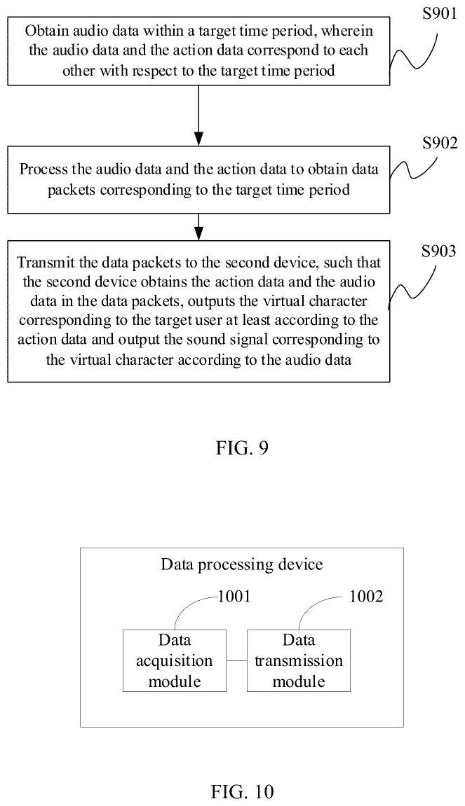

In one embodiment, S102 for transmitting the action data to the second device may include S901 to S903, as shown in FIG. 9.

In S901, audio data in a target time period may be obtained. The audio data and action data may correspond to each other with respect to the target time period.

The target time period may be 1 second or 0.5 seconds long. That is, in this embodiment, the action data may be transmitted every target time period.

In S902, the audio data and action data may be processed to obtain data packets corresponding to the target time period.

In one embodiment, the audio data and action data may be divided into data blocks according to the timestamps in the target time period, to obtain a first data block corresponding to each timestamp in the audio data and a second data block corresponding to each time stamp in the action data. Subsequently, according to each timestamp, the first data block and the second data block corresponding to the same timestamp may be processed, such as by splicing or packaging, to obtain the data packet corresponding to each timestamp. These data packets may form the data packets corresponding to the target time period.

In S903, the data packets may be transmitted to the second device, such that the second device obtains the action data and audio data in the data packets. The second device may output the virtual character corresponding to the target user at least according to the action data and output the audio signal corresponding to the virtual character according to the audio data.

In the present embodiment, according to the sequence between the timestamps corresponding to the data packets, each data packet may be transmitted to the second device. Therefore, after receiving each data packet, the second device may first decode the data packet. For example, the first data block and the second data block in each data packet may be first extracted. Then, the first data blocks may be combined according to the timestamps, and the second data block may be combined according to the timestamps, to obtain the decoded audio data and action data. The second device may output the virtual character corresponding to the target user at least according to the decoded action data and output the audio signal corresponding to the virtual character according to the decoded audio data.

The second device may extract the audio signal from the audio data, and then output the extracted audio signal as the audio signal corresponding to the virtual character. Or, the second device may perform signal conversion on the extracted audio signal, for example, according to specific parameters such as timbre or sound quality. Then the converted audio signal may be output as the audio signal corresponding to the virtual character.

Further, the second device may control the virtual character to perform corresponding actions based on the extracted audio signal. For example, the mouth of the virtual character may be controlled to open or close based on the audio signal.

In this embodiment, the action data and audio data may be multiplexed into the same data packets, thereby reducing the data transmission delay through the transmission of small data packets and improving data transmission efficiency. Furthermore, the control performance of the second device on the virtual character may be improved and the utilization of transmission resources may also be improved.

In one embodiment, when the second device outputs the virtual character corresponding to the target user based on the action data, the interaction information of the virtual character may be recorded. The interaction information may be stored in a storage area in the electronic device formed by a storage device, such that the first device is able to obtain the recorded interaction information and provide the interaction information to the target user as reference information.

The interaction information may include at least one of text keywords, voice clips, or video clips corresponding to the virtual character.

In one embodiment, the interaction information may be sent by the second device to the first device after being recorded, to be provided to the operator of the first device as reference information for performing corresponding actions.

In some other embodiments, the interaction information may be retrieved by the first device from the storage area in the second device, to be provided to the operator of the first device as reference information for performing corresponding actions.

In some embodiments, multimedia interaction data corresponding to the virtual character may be obtained on the first device. The multimedia interaction data may include multimedia data for interaction between the virtual character and the user of the second device. In one embodiment, the multimedia interaction data may at least include video data and/or audio data of the user of the second device. For example, the multimedia interaction data may include customer images, customer voices, or other data during the interaction between the customer on the counter and the virtual character output by the counter.

In some embodiments, the first device may receive the multimedia interaction data sent by the second device in real time; or, the second device may send the multimedia interaction data collected in real time to the cloud server, and the first device may retrieve the multimedia interaction data from the cloud server in real time.

For example, in one embodiment, the target user may be a customer service staff sitting in front of a camera installed indoors. Through the image collection of the camera and the acquisition and transmission of the action data, the corresponding virtual human may be output for the customer on the outdoor counter, and the real-time video image of the customer on the counter may be output in the room where the customer service staff is located. Therefore, the customer on the counter and the virtual human output by the counter may perform interaction in real time, and the customer service staff may provide service to the customer according to the customer's real-time video images in conjunction with the historical interaction information between the customer and the virtual human.

Therefore, in the present disclosure, the target user on the first device may be able to learn the current status of the user of the second device in real time, and thereby provide corresponding services to the user of the second device in a timely manner. Further, the target user on the first device may also provide corresponding services to the user of the second device in combination with the obtained historical interaction information corresponding to the virtual character, to avoid repeatedly providing the same or similar services. Correspondingly, the user of the second device may be able to receive faster and more effective services, thereby improving the user's experience with the virtual character.

The present disclosure also provides a data processing device. The data processing device may be disposed in an electronic device capable of processing data, such as the first device shown in FIG. 2. In the present disclosure, the amount of data transmission between devices may be reduced when the virtual character is output on the device.

In one embodiment shown in FIG. 10 which is a structural schematic diagram of a data processing device, the device may include:
a data acquisition module 1001, configured to obtain action data of a target user; and
a data transmission module 1002, configured to transmit the action data to the second device, such that the second device outputs the virtual character corresponding to the target user at least according to the action data.

In the data processing device provided by the present disclosure, after obtaining the action data of the target user on the first device, the action data may be transmitted to the second device and the second device may output the target virtual character corresponding to the target user according to the action data. Instead of the data of the target character, the action data for outputting the target character may be transmitted between the first device and the second device in the present disclosure, and the data amount of the action data may be significantly smaller than the data amount of the virtual character. Therefore, in the present disclosure, when the virtual character is output on the devices, the action data with the smaller data amount may be transmitted between the devices, reducing the amount of data transmission between devices.

In one embodiment, the data acquisition module 1001 may be configured to: obtain a target image including an image region corresponding to the target user, and obtain the action data of the target user based on the target image.

In one embodiment, one frame of target image may include multiple target sub-images, and one target sub-image may include an image area of a part of the target user. When being configured to obtain the action data of the target user based on the target image, the data acquisition module 1001 may be specifically configured to: obtain action sub-data of the target user on one part corresponding to one target sub-image based on the corresponding target sub-image. All action sub-data may constitute the action data of the target user.

In one embodiment, one target sub-image may be obtained through one corresponding image acquisition device, and the image acquisition devices corresponding to the target sub-images of different parts may have different image acquisition parameters. The image acquisition parameters may include at least one of acquisition resolution or acquisition range.

In another embodiment, all target sub-images in one frame of the target image may be obtained through one image acquisition device, and the target sub-images may be obtained by region division of the target image according to the parts of the target user.

In one embodiment, when being configured to obtain action sub-data of the target user on one part corresponding to one target sub-image based on the corresponding target sub-image, the data acquisition module 1001 may be specifically configured to: processing the target sub-images separately according to multiple processing methods to obtain the action sub-data of the target user on the part corresponding to the target sub-object. Different target sub-objects may correspond to different processing methods.

In one embodiment, the data acquisition module 1001 may be configured to: according to various processing methods, obtain multiple pieces of action sub-data of the target user respectively. One piece of action sub-data may correspond to one part of the target user, and all the pieces of action sub-data may form the action data of the target user. Different action sub-data may correspond to different processing methods.

In one embodiment, the action sub-data may be obtained based on target sub-data, and one piece of target sub-data may correspond to one part of the target user. The processing methods for obtaining the action sub-data may be based on acquisition modes of the data acquisition devices. The data acquisition devices may be used to obtain target sub-data. The data acquisition devices corresponding to some different parts may have different types, or the data acquisition devices corresponding to some different parts may have different device parameters. The device types of the data acquisition devices may be the device types of the image acquisition devices or the device type of the wearable devices. The device parameters of the data acquisition devices may include: image acquisition resolution of the image acquisition devices, or sensor acquisition density of the wearable devices.

In one embodiment, the action sub-data may be obtained based on target sub-data, and one piece of target sub-data may correspond to one part of the target user. The processing methods for obtaining the action sub-data may be the methods for processing target sub-data, and different parts may correspond to different processing parameters for processing target sub-data. The processing parameters may include at least one of: accuracy of processing the target sub-data or frame rate of processing the target sub-data.

In one embodiment, the data transmission module 1002 may be configured to: obtain audio data in a target time period may be obtained, where the audio data and action data may correspond to each other with respect to the target time period; processing the audio data and action data to obtain data packets corresponding to the target time period; and transmit the data packets to the second device, such that the second device obtains the action data and audio data in the data packets. The second device may output the virtual character corresponding to the target user at least according to the action data and output the audio signal corresponding to the virtual character according to the audio data.

For the implementation of the different modules in the device embodiments, references may be made to the previous description of the method embodiments.

The present disclosure also provides an electronic device. The electronic device may be a computer or a server, such as the first device shown in FIG. 2.

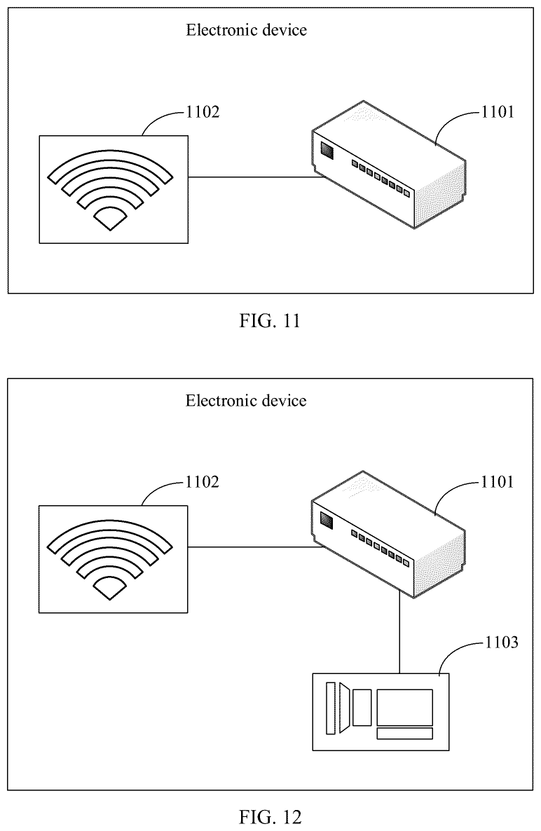

In one embodiment shown in FIG. 11 which is a structural schematic diagram of an electronic device, the device may include:
a processor 1101, configured to obtain action data of a target user; and
a transmitter 1102, configured to transmit the action data to a second device, such that the second device outputs the virtual character corresponding to the target user at least according to the action data.

The processor 1101 may be configured to obtain the action data of the target user through a single processor core or a plurality of processor cores. The transmitter 1102 may be configured to be a structure with a wireless mode and/or a wired mode, to transmit the action data to the second device.

In the data processing device provided by the present disclosure, after obtaining the action data of the target user on the first device, the action data may be transmitted to the second device and the second device may output the target virtual character corresponding to the target user according to the action data. Instead of the data of the target character, the action data for outputting the target character may be transmitted between the first device and the second device in the present disclosure, and the data amount of the action data may be significantly smaller than the data amount of the virtual character. Therefore, in the present disclosure, when the virtual character is output on the devices, the action data with the smaller data amount may be transmitted between the devices, reducing the amount of data transmission between devices.

In one embodiment, as shown in FIG. 12, the electronic device may further include an image acquisition device 1103, configured to: collect a target image including an image region corresponding to the target user. Correspondingly, the processor 1101 may be configured to obtain the target image and obtain the action data of the target user based on the target image.

In one embodiment, one frame of target image may include multiple target sub-images, and one target sub-image may include an image area of a part of the target user. When being configured to obtain the action data of the target user based on the target image, the processor 1101 may be specifically configured to: obtain action sub-data of the target user on one part corresponding to each target sub-image based on the corresponding target sub-image through the plurality of processor cores. All action sub-data may constitute the action data of the target user.

In one embodiment, one target sub-image may be obtained through one corresponding image acquisition device 1103, and the image acquisition devices 1103 corresponding to the target sub-images of different parts may have different image acquisition parameters. The image acquisition parameters may include at least one of acquisition resolution or acquisition range.

In another embodiment, all target sub-images in one frame of the target image may be obtained through one image acquisition device 1103, and the target sub-images may be obtained by region division of the target image according to the parts of the target user.

In one embodiment, when being configured to obtain action sub-data of the target user on one part corresponding to one target sub-image based on the corresponding target sub-image, the processor 1101 may be specifically configured to: processing the target sub-images separately according to multiple processing methods to obtain the action sub-data of the target user on the part corresponding to the target sub-object. Different target sub-objects may correspond to different processing methods.

In one embodiment, the processor 1101 may be configured to: according to various processing methods, obtain multiple pieces of action sub-data of the target user respectively. One piece of action sub-data may correspond to one part of the target user, and all the pieces of action sub-data may form the action data of the target user. Different action sub-data may correspond to different processing methods.

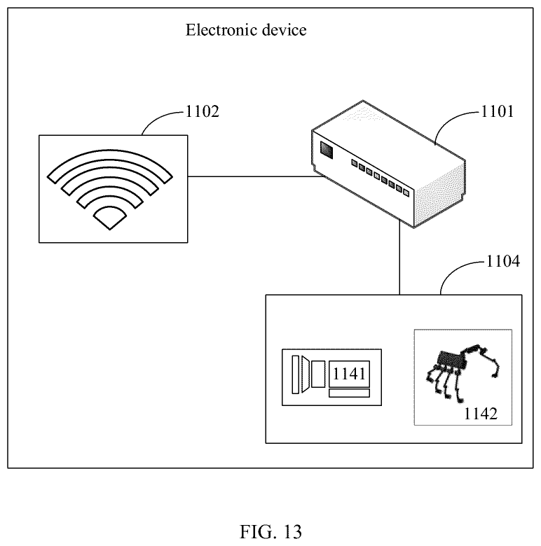

In one embodiment, as shown in FIG. 13, the electronic device may further include a data acquisition device 1104 including an image acquisition device 1141 and/or a wearable device 1142.

In the present embodiment, the action sub-data may be obtained based on target sub-data, and one piece of target sub-data may correspond to one part of the target user. The processing methods for obtaining the action sub-data may be based on acquisition modes of the data acquisition device 1104. The data acquisition device 1104 may be used to obtain target sub-data. The data acquisition device 1104 corresponding to some different parts may have different types, or the data acquisition device 1104 corresponding to some different parts may have different device parameters. The device types of the data acquisition device 1104 may be the device types of the image acquisition devices or the device type of the wearable devices. The device parameters of the data acquisition device 1104 may include: image acquisition resolution of the image acquisition devices, or sensor acquisition density of the wearable devices.

In one embodiment, the action sub-data may be obtained based on target sub-data, and one piece of target sub-data may correspond to one part of the target user. The processing methods for obtaining the action sub-data may be the methods for the processor 1101 to process corresponding target sub-data, and different parts may correspond to different processing parameters for processing target sub-data. The processing parameters may include at least one of: accuracy of processing the target sub-data or frame rate of processing the target sub-data.

In one embodiment, the transmitter 1102 may be configured to: obtain audio data in a target time period may be obtained, where the audio data and action data may correspond to each other with respect to the target time period; processing the audio data and action data to obtain data packets corresponding to the target time period; and transmit the data packets to the second device, such that the second device obtains the action data and audio data in the data packets. The second device may output the virtual character corresponding to the target user at least according to the action data and output the audio signal corresponding to the virtual character according to the audio data.

For the implementation of the different modules in the device embodiments, references may be made to the previous description of the method embodiments.

The present disclosure will be described by using an interaction scenario of the virtual human in smart customer service as an example.

Virtual humans have gradually matured, and many companies have introduced virtual humans as unified images. As an innovative way of use, the present disclosure provides an application that drives virtual humans based on real-person facial expression and action capture, replacing the front desks of service departments such as banks. Not only a unified image of personnel may be achieved instead of imposing strict restrictions on the image of service personnel, but also centralized services, similar to call centers may be achieved to reduce costs and achieve a real interactive experience.

In existing technologies, action capture systems are mostly used in industries such as film, television or game production. These systems have serious problems when used in the application scenario in the present disclosure. For example, the amount of data transmission of the virtual humans is large, therefore the virtual human's output at the output end may be stuck. Also, the action capture system needs to be wearable, which is difficult to use and extremely costly. Further, the action capture system lacks the ability to capture data remotely.

The present disclosure provides an action capture solution based on vision. The action data may be captured at an acquisition end device (with respect to the target user or operator, it can also be called a near-end device) through image acquisition and processing, and transmitted to the output end device (with respect to the target user or operator, it can also be called a remote device) to control the virtual human. Further, according to the tracking accuracy requirements, a variety of different capture subsystems or algorithms such as the face, body, or hands, may be obtained by splitting, and different configurations of capture cameras and different capture algorithms may be adopted. The captured action data and voice data may be multiplexed into the same data packets, and the data packets may be demultiplexed on the remote device. The action capture data (i.e., the action data) may be used for real-time rendering to generate realistic virtual human image and interaction process.

In the present disclosure, the mode of transmitting action capture data may be adopted. The data packets may be small, the delay may be small, and the transmission may be fast. For the user of the remote device, the virtual human's actions may be quick and responsive. Furthermore, when a data packet is lost, the remote device may make predictions based on the received data packets to achieve dynamic frame interpolation to avoid lags in the output of the virtual human. Also, action capture may be based on vision, and the operator may not need to wear complicated equipment, making the use process more comfortable and reducing the cost. The body in the image may be split into multiple parts and different capture devices and algorithms may be adopted according to different accuracy requirements, improving the overall accuracy and performance.

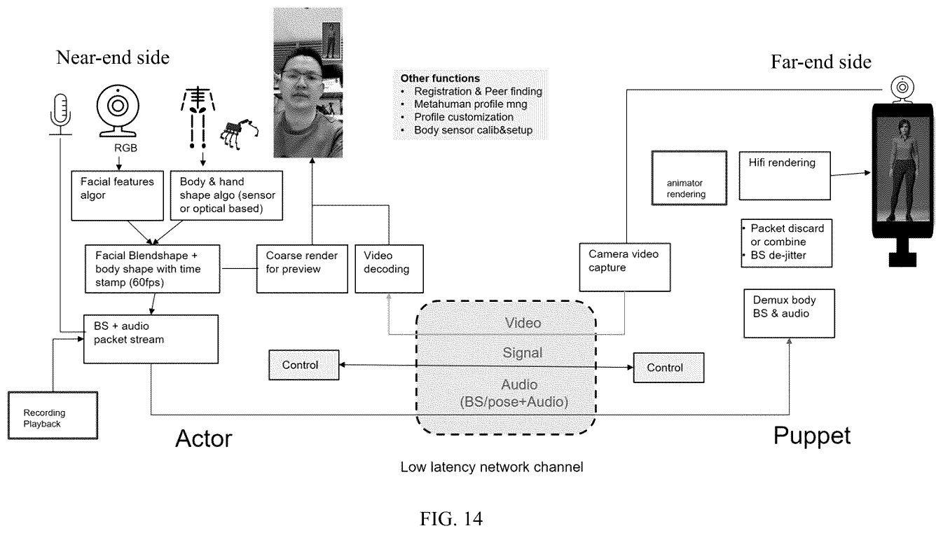

As shown in FIG. 14, in one embodiment, on the near-end side, the target user such as the operator may be provided with a microphone to collect sound signals, an RGB camera to collect images, and a wearable device worn on the operator's fingers and other parts. The wearable device may include multiple sensors to collect the action data of the key points on the wearing parts. On the far-end side, devices such as displays, microphones, or cameras may be configured for customers.

On the near-end side, a best position frame for image acquisition may be output to the operator on the near-end side to remind the operator to enter the position frame through position movement. It may prompt the operator to sit in a suitable position when his seat is too far away. Based on this, audio data may be obtained on the near-end side. The audio data may include sound signals collected by the microphone or preset recordings (i.e. recording playback). The RGB camera on the near-end side may collect images of the operator. The facial features algorithm may be used to process the sub-image of the facial area to obtain the action parameters of multiple key points on the face to characterize the facial expressions or actions. The sensor of the wearable device worn by the operator on the finger may collect sensor collection parameters on the fingers. The RGB camera may collect sub-images of the body area for the operator. Based on this, the sensor collection parameters and body area sub-images may be processed based on the body and hand shape processing algorithm (Body & hand shape algo) to obtain the action data of the body and fingers (that is, sensor or optical based). Subsequently, the action data of the facial expression and the body and fingers may be mixed according to a preset frame rate time stamp, such as 60 fps, to obtain the action data of the operator (i.e. Facial blend shape+body shape).

The audio data and action data may form a data packet stream according to the time stamps, that is, BS+audio packet stream. The BS (blend shape) here refers to the operator's action data obtained by mixing in the previous description.

The data packet stream may be transmitted to the remote device through a low latency network channel. The low latency network channel may be used to transmit video data (video), mixed data such as data packets including action data (BS/pose) and audio data (audio), or other signals.

Further, on the near-end device, the operator's action data may also be used to control the action of the virtual human output by the near-end side. That is, the image collected by the RGB camera may be output to the operator on the near-end device, and also the corresponding virtual human may be rendered for the operator and may be controlled on the near-end side based on the obtained action data (Coarse render for preview), which realizes the rendering preview of the virtual human on the near-end side.

On the far-end side, after the far-end side receives the data packet stream transmitted by the near-end side, the data packet stream may be parsed to parse the audio data and action data in the data packets, that is, Demux body BS & audio.

Then, the virtual human may be output on the far-end side through animation rendering (Hifi animator rendering) using a specific rendering tool, and the virtual human may be controlled to perform corresponding actions based on the action data. Therefore, a high-fidelity Hifi rendered three-dimensional virtual human may be output on the display screen on the far-end side.

Further, on the far-end side, when the data confidence of the action data in the data packets is low or does not meet the constraints, the action data may be discarded and the action data at the current moment may be predicted through historical data (that is, Packet discard or combine and BS de-jitter).

In addition, the far-end side may collect video data of the customer through the camera and transmit the video data to the near-end side such that the customer's video data is able to be output on the near-end side (that is, Camera video capture). Therefore, the customer on the far-end side may be able to watch the virtual human (Puppet) of the near-side operator and the actions of the virtual human may be consistent with the actions of the near-side operator (Actor). The near-side operator may not only be able to preview the virtual human, but also be able to watch the video data of the remote customer, such that the near-side operator is able to understand the customer's situation in time and provide corresponding services.

Also, in this embodiment, other functions may also be implemented on the near-end side, such as customer registration and customer discovery (Registration & peer finding), virtual human profile manager (Meta human profile manager), configure file customization (Profile customization), action data correction and initialization (Body sensor calib &setup), and so on.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element defined by the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A data processing method applied to a first device, comprising:
obtaining action data of a target user; and
transmitting the action data to a second device, such that the second device outputs a virtual character corresponding to the target user at least according to the action data.

2. The method according to claim 1, wherein obtaining the action data of the target user includes:
obtaining a target image including an image region corresponding to the target user; and
obtaining the action data of the target user according to the target image.

3. The method according to claim 2, wherein:
the target image includes a plurality of target sub-images each including an image area of a part of the target user; and
obtaining the action data of the target user according to the target image includes:
obtaining action sub-data of various parts of the target user that correspond to respective ones of the plurality of target sub-images according to the plurality of target sub-images, respectively, the action sub-data obtained from all of the plurality of target sub-images constituting the action data of the target user.

4. The method according to claim 3, wherein:
the plurality of target sub-images are obtained by a plurality of image acquisition devices, respectively, and image acquisition parameters of the image acquisition devices corresponding to the plurality of target sub-images of different parts of the target user are different; and
each of the image acquisition parameter includes at least one of acquisition resolution or acquisition range.

5. The method according to claim 3, wherein:
all of the plurality of target sub-images in the target image are obtained through an image acquisition device; and
the plurality of target sub-images are obtained by regionally dividing the target image according to the parts of the target user.

6. The method according to claim 3, wherein:
obtaining the action sub-data of the various parts of the target user that correspond to the respective ones of the plurality of target sub-images according to the plurality of target sub-images, respectively, includes:
processing the plurality of target sub-images respectively according to a plurality of processing methods to obtain the action sub-data of the target user on the various parts corresponding to the plurality of target sub-images respectively; and
the plurality of processing methods are different for different ones of the plurality of target sub-images.

7. The method according to claim 1, wherein obtaining the action data of the target user includes:
obtaining a plurality of pieces of action sub-data of the target user according to a plurality of processing methods respectively, each of the plurality of pieces of action sub-data corresponding to one part of the target user, all of the plurality of pieces of action sub-data constituting the action data of the target user, and the plurality of processing methods are different for different ones of the plurality of pieces of action sub-data.

8. The method according to claim 7, wherein the plurality of pieces of action sub-data are obtained based on a plurality of pieces of target sub-data each corresponding to one part of the target user.

9. The method according to claim 8, wherein the plurality of processing methods are based on data acquisition devices used to obtain the plurality of pieces of target sub-data.

10. The method according to claim 9, wherein device types of the data acquisition devices corresponding to different parts of the target user are different or device parameters of the data acquisition devices corresponding to different parts of the target user are different.

11. The method according to claim 10, wherein the device types of the data acquisition devices include device types of image acquisition devices.

12. The method according to claim 11, wherein the device parameters of the data acquisition devices include image acquisition resolutions of the image acquisition devices.

13. The method according to claim 10, wherein device types of the data acquisition devices include device types of wearable devices.

14. The method according to claim 13, wherein the device parameters of the data acquisition devices include sensor acquisition densities of the wearable devices.

15. The method according to claim 8, wherein:
the plurality of processing methods include methods for processing the plurality of pieces of target sub-data; and
processing parameters used for processing the plurality of pieces of target sub-data corresponding to different parts of the target user are different.

16. The method according to claim 15, wherein each of the processing parameters includes at least one of accuracy for processing the corresponding target sub-data or frame rate for processing the corresponding target sub-data.

17. The method according to claim 1, wherein transmitting the action data to the second device includes:
obtaining audio data within a target time period, the audio data and the action data corresponding to each other with respect to the target time period;
processing the audio data and the action data to obtain a data packet corresponding to the target time period; and
transmitting the data packet to the second device, such that the second device obtains the action data and the audio data in the data packet, outputs the virtual character corresponding to the target user at least according to the action data, and outputs a sound signal corresponding to the virtual character according to the audio data.

18. An electronic device comprising:
a processor configured to obtain action data of a target user; and
a transmitter configured to transmit the action data to a second device, such that the second device outputs a virtual character corresponding to the target user at least according to the action data.

19. The electronic device according to claim 18, wherein the processor is further configured to:
obtain a target image including an image region corresponding to the target user; and
obtain the action data of the target user according to the target image.

20. The electronic device according to claim 19, wherein:
the target image includes a plurality of target sub-images each including an image area of a part of the target user; and
the processor is further configured to:
obtain action sub-data of various parts of the target user that correspond to respective ones of the plurality of target sub-images according to the plurality of target sub-images, respectively, the action sub-data obtained from all of the plurality of target sub-images constituting the action data of the target user.
